(19) United States
(12) Patent Application Publication
(10) Pub. No.: US 2016/0337560 A1
(43) Pub. Date: Nov. 17, 2016

(54) REMOVABLE DUAL USE SPORTS AND TRAIL CAMERA

(71) Applicant: Fourth Arrow, LLC, Comstock Park, MI (US)

(72) Inventor: Robert M. Wynalda, JR., Comstock Park, MI (US)

(21) Appl. No.: 15/155,836

(22) Filed: May 16, 2016

Related U.S. Application Data
(60) Provisional application No. 62/162,575, filed on May 15, 2015.

(51) Int. Cl. H04N 5/225; F21V 23/04; G03B 15/02

(52) U.S. Cl. CPC H04N 5/2252; G03B 15/02; F21V 23/0471; H04N 5/2256; H04N 5/2254; F21Y 2101/02

(57) ABSTRACT

A trail camera assembly includes a trail camera enclosure and an independent camera that is removable from the trail camera assembly and usable as a normal digital camera. The independent camera is in the form of a digital camera that has its own power supply, lens, storage device, and electronic controls such that it functions as a digital camera outside of the trail camera assembly. The trail camera enclosure includes a sensor, a light, and an independent power supply. When the two are combined, the assembly can be used as a trail camera.

### CROSS REFERENCE TO RELATED APPLICATIONS

This application claims the benefit of U.S. Provisional Patent Application Ser. No. 62/162,575 filed May 15, 2015; the disclosures of which are incorporated herein by reference.

### BACKGROUND OF THE DISCLOSURE

1. Technical Field

The disclosure generally relates to game or trail cameras use by hunters for game surveillance. More particularly, the disclosure relates to a game or trail camera enclosure and assembly that uses a removable camera that can be used outside of the trail camera enclosure for other photography applications.

2. Background Information

Wildlife observation cameras are used by photographers who wish to capture images of illusive animals or to obtain close up views. When used by hunters to surveil game, the cameras are called game cameras or trail cameras. These cameras have a sensor or a plurality of sensors that trigger the photo-taking camera function. The components of the trail camera are carried by a weatherproof, rugged enclosure that is typically mounted at an outdoor location such as on a tree, a fence, or a mount and left unattended. A hunter may only use such a camera for a few days or weeks each year during the hunting season of his choice. The remaining weeks finds the trail camera in storage.

### SUMMARY OF THE DISCLOSURE

The disclosure provides a trail camera assembly having a trail camera enclosure and an independent camera that is removable from the trail camera assembly and usable as a normal digital camera. The independent camera is in the form of a digital camera that has its own power supply, lens, storage device, and electronic controls such that it functions as a digital camera outside of the trail camera assembly. The trail camera enclosure includes a sensor, a light, and an independent power supply. When the two are combined, the assembly can be used as a trail camera.

In one configuration, the independent camera can be placed into other enclosures to form additional camera assemblies. This allows a plurality of enclosures to be securely mounted in different locations and the owner can move the camera between the enclosures as desired.

In one exemplary configuration, the independent camera draws power (either primary or supplemental) from the independent power supply of the trail camera assembly enclosure.

In one exemplary configuration, the independent camera can be configured for still photo mode, burst photo mode, or video mode.

In one configuration, the trail camera assembly includes a wireless communication module to allow a person to remotely access the photos. The wireless communication module can allow the person to remotely change the setting of the camera.

In one configuration, the trail camera assembly uses the display screen and controls of the independent camera to view images and to change settings. In another configuration, the trail camera assembly has a second display screen for viewing images taken from the independent camera and independent controls for changing the settings of the trail camera assembly.

The preceding non-limiting aspects, as well as others, are more particularly described below. A more complete understanding of the processes and equipment can be obtained by reference to the accompanying drawings, which are not intended to indicate relative size and dimensions of the assemblies or components thereof. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a front elevation view of an exemplary trail camera with removable independent camera.

FIG. 2 is a front elevation view of the exemplary trail camera with the enclosure in the open configuration.

FIG. 3 is a rear elevation of the exemplary trail camera.

Similar numbers refer to similar parts throughout the disclosure. The drawings are not to scale.

### DETAILED DESCRIPTION OF THE EXEMPLARY EMBODIMENTS

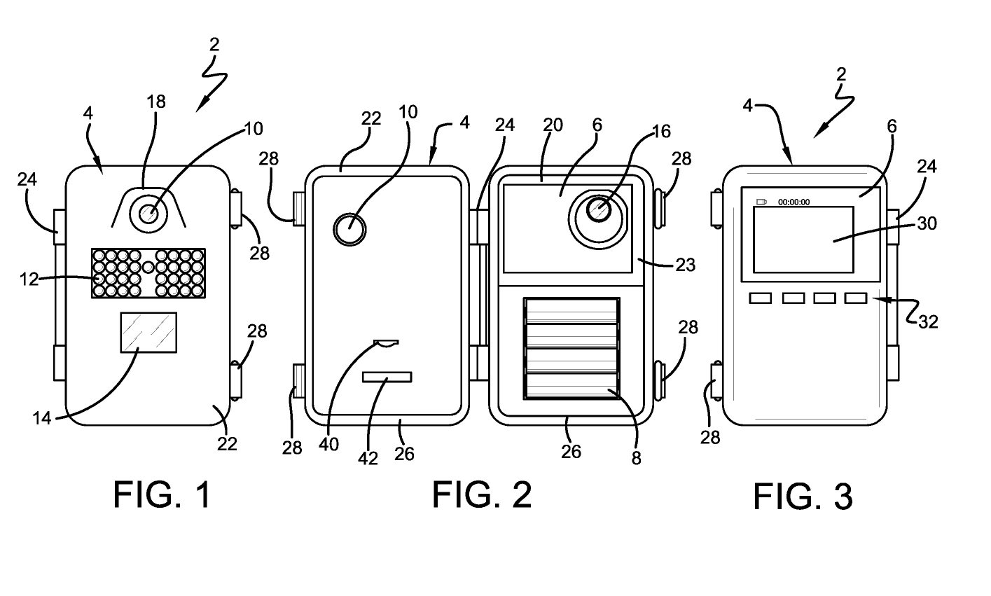

An exemplary configuration of the trail camera assembly is indicated generally by the reference numeral 2 in the accompanying drawings. Assembly 2 generally includes a trail camera enclosure 4 and an independent digital camera 6 that is removably carried by enclosure 4. When camera 6 is carried by enclosure 4, assembly 2 can be used as a trail camera that takes a photo in response to the triggering of a sensor. In the exemplary configuration, enclosure 4 includes an independent power supply 8, a lens cover 10, a light source 12, and a sensor 14. Camera 6 is removable from enclosure 4 and usable as a stand-alone digital camera. Camera 6 thus includes its own power supply, a lens, a display screen, memory, controls, and the electronic components found in a typical digital camera to provide for the camera's operation. Camera 6 includes one or more input ports for allowing the assembly components external to camera 6 to interact with camera 6. The connections between these components and the ports can be made automatically when camera 6 is seated within enclosure 4 or can be made after camera 6 is seated. A wireless communications protocol such as Bluetooth can be used to provide the communication between enclosure 4 and camera 6. When seated within enclosure 4, the lens 16 of camera 6 is aligned with lens cover 10. Lens cover 10 can be a transparent protective member with no optics or can be a lens configured to enhance the image taken by camera 6. For example, lens cover 10 can be a wide angle lens. Lens covers 10 can be removed and changed. A protruding shroud 18 can be disposed around lens cover 10 to protect it from rain, dust, and pollen. Shroud 18 can be disposed entirely around lens cover 10 or just on the sides and above lens cover 10 as depicted in FIG. 1.

Enclosure 4 generally includes a base 20 and a cover 22 that is movable on a hinge 24 between open and closed configurations. Base 20 can be configured to hold a specific type of camera 6 or can be adjustable by having different removable seats 23 for different cameras. Seats 23 can be purchased for a specific camera or the seats 23 can be formable polymer or foam that are configured by the end user. For example, base 20 can include a seat for a cell phone usable as a camera. Alternatively, seat 23 can include a plurality of holding fingers that snap into base 20 with different finger configuration being provided for different cameras 6. Such holding fingers can be deformable to allow the user to make custom adjustments. A perimeter seal 26 makes enclosure 4 water proof when cover 22 is closed. Enclosure 4 is a tough, weatherproof enclosure that may be formed from a metal or a polymer. Enclosure can include padding for the components of assembly 2 to allow assembly to withstand drops. A latch 28 or a plurality of latches 28 are used to hold cover 22 closed tight to base 20. Each latch 28 can be a snap-style latch or a type of latch that requires manipulation of a connector such as a screw or bolt. Assembly can optionally include a lock.

In one configuration, enclosure 4 can include a window 30 that allows the rear display screen of camera 6 to be viewed through enclosure 4. Window 30 can allow the controls of camera 6 to be access by pressing on window 30 or window 30 can be opened to provide for access to the display screen and controls of camera 6 to be accessed directly. In another configuration, enclosure 4 provides its own display screen 30 that display information and images from camera 6. This display screen can be an LCD screen. Enclosure 4 also can include controls 32 that allow the user to control camera 6 from outside enclosure 4. In another configuration, camera 6 or assembly 2 includes a wireless communications module that allows images to be accessed wirelessly and/or the settings of camera 6 to be changed wireless such as from software from a portable computer such as a tablet or phone. WIFI, Bluetooth, or cellular RF wireless communications modules can be provided.

Although camera 6 typically has its own internal power supply, independent power supply 8 can be used to power light source 12 and sensor 14 as well as an independent wireless communication module. Independent power supply 8 also can power camera 6 as its primary power or as supplemental power. Independent power supply 8 can include disposable batteries, rechargeable batteries or a rechargeable battery, or a combination of these with a solar panel. The electrical connections can be a direct wire or plug extending between base 20 and cover 22 or electrical connections disposed through hinge 24, through latches 28, or through an electrical connection that is formed when cover 22 is closed and latched.

Light source 12 can be one or more incandescent bulbs or a plurality of light emitting diodes (LEDs) carried by a circuit board. Light source 12 also can include infrared emitters alone or in combination with visible light emitters so assembly 2 can be configured for infrared photography as well as visible light photography. Light source 12 can be exposed to the exterior of enclosure 4 or can be disposed behind a protective screen.

Sensor 14 can be a motion sensor or a heat sensor. Digital controls are provided within enclosure 4 or within camera 6 to cause light source 12 to active and camera 6 to take an image when sensor 14 create a signal.

In one configuration, assembly 2 includes a plurality of different enclosures 4 with components configured for different applications options. The hunter can select the enclosure configuration for the desired application and place camera 6 within enclosure for use. The hunter can then remove camera 6 and place it into a different enclosure configuration for a different application. For example, different enclosures 4 can be provided in different camouflage patterns, colors, or textures. One example is an external appearance that matches tree bark and different enclosures can be provided for different locations. For example, one assembly can include a cellular RF communications module usable when a cell tower signal is available. Another assembly configuration can include an enclosure of a different size and with a different mounting option. Another assembly configuration can include an enclosure 4 useful for underwater photography with no sensor 14, a light source 12 configured for underwater use, and a control 32 that allows the user to trigger the taking of the image. Another enclosure 4 can be configured to be mounted to a sports helmet such as a ski or bike helmet. Another enclosure can be secured to a wearable harness or directly to a bicycle. Another enclosure configuration can be configured to be secured to a pole so the user can take images of himself. As described above, camera 6 can be removed and used as a normal camera.

A communications port 40 can be provided to allow a computer to be connected to assembly 2 to access images on camera 6 or to change the settings of assembly 2. An independent memory card slot 42 can be provided for storage of images independent of camera 6. Port 40 and slot 42 can be located in a position accessible when enclosure 4 is closed or in a position accessible when enclosure 4 is open.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Modifications and alterations of those embodiments will be apparent to one who reads and understands this general description. The present disclosure should be construed as including all such modifications and alterations insofar as they come within the scope of the appended claims or equivalents thereof. Throughout the description and claims of this specification the words “comprise” and “include” as well as variations of those words, such as “comprises,” “includes,” “comprising,” and “including” are not intended to exclude additives, components, integers, or steps.

1. A trail camera enclosure that allows a digital camera to be used as a trail camera; the enclosure comprising:
an enclosure adapted to removably carry a digital camera in a seat; and
the enclosure having a sensor, a light, and an independent power supply.

2. The trail camera enclosure of claim 1, wherein the enclosure includes a lens cover aligned with the seat of the enclosure.

3. The trail camera enclosure of claim 2, wherein the lens cover is a transparent protective member.

4. The trail camera enclosure of claim 2, wherein the lens cover defines optics adapted to enhance the image taken by the digital camera.

5. The trail camera enclosure of claim 2, wherein the lens cover is aligned with the seat.

6. The trail camera enclosure of claim 2, wherein the lens cover is removable and replaceable.

7. The trail camera enclosure of claim 2, wherein the enclosure defines a shroud disposed around a portion of the lens cover.

8. The trail camera enclosure of claim 1, wherein the enclosure includes a base and a cover that is movable between open and closed configurations.

9. The trail camera enclosure of claim 8, wherein the cover is connected to the base with a hinge.

10. The trail camera enclosure of claim 9, further comprising a seal that makes the enclosure waterproof when the base and cover are in the closed configuration.

11. The trail camera enclosure of claim 1, wherein the enclosure defines a window aligned with the seat such that the digital camera can be viewed through the window.

12. The trail camera enclosure of claim 1, wherein the enclosure includes an enclosure display.

13. The trail camera enclosure of claim 12, wherein the display is an LCD screen.

14. The trail camera enclosure of claim 1, wherein the seat is removable and replaceable.

15. The trail camera enclosure of claim 1, wherein the light includes a plurality of light emitting diodes.

16. The trail camera enclosure of claim 1, wherein the sensor is a motion sensor.

17. A trail camera enclosure that allows a digital camera to be used as a trail camera; the enclosure comprising:
an enclosure adapted to removably carry a digital camera in a seat;
the enclosure having a sensor, a light, and an independent power supply;
the sensor being a motion sensor adapted to turn on the light and adapted to send a signal to the digital camera to take a photo.

18. The trail camera enclosure of claim 17, wherein the light includes a plurality of light emitting diodes.

19. A trail camera enclosure that allows a digital camera to be used as a trail camera; the enclosure comprising:
an enclosure adapted to removably carry a digital camera in a seat; the enclosure including a base and a cover that is movable between open and closed configurations;
the cover of the enclosure having a sensor and a light; and
the sensor being a motion sensor adapted to turn on the light and adapted to send a signal to the digital camera to take a photo.

20. The trail camera enclosure of claim 19, wherein the base of the enclosure defines the seat for the digital camera; the base of the enclosure defining a window.
